(19) United States
(12) Patent Application Publication
(10) Pub. No.: US 2016/0131179 A1
(43) Pub. Date: May 12, 2016

(54) SEALANT CAP

(71) Applicant: SYSTEMS AND MATERIALS RESEARCH CORPORATION, Austin, TX (US)

(72) Inventors: Malcolm D. PROUTY, Austin, TX (US); Christopher Y. INGHAM, Austin, TX (US); Chelsea C. BOUNDY, Austin, TX (US)

(21) Appl. No.: 14/898,113

(22) PCT Filed: Jun. 11, 2014
(86) PCT No.: PCT/US14/42020

§ 371 Date: Dec. 11, 2015

Related U.S. Application Data
(60) Provisional application No. 61/833,725, filed on Jun. 11, 2013.

(51) Int. Cl. F16B 43/00

(52) U.S. Cl. CPC F16B 43/001

(57) ABSTRACT

An improved process for applying sealant to the backside of fasteners. Preferred embodiments of the present invention use a novel sealant cap as a mold for applying sealant. Embodiments of the present invention are especially suited for applying sealant to the backside of fasteners used in aircraft production. In preferred embodiments, the sealant caps allow the application of a metered amount of sealant only at the required/desired locations around an installed aircraft fastening element. Embodiments of the present invention thus prevent the over/under application of sealant and reduce the amount of time required to seal a fastener.

### CROSS-REFERENCE TO RELATED APPLICATION

The present application claims priority from PCT Application No. PCT/US 14/42020, filed Jun. 11, 2014, entitled “SEALANT CAP” by Malcolm D. Prouty et al., which in turn claims priority from U.S. Provisional Patent Application Ser. No. 61/833,725 filed Jun. 11, 2013, entitled “SEALANT CAP” by Malcolm D. Prouty et al., all of which are all incorporated by reference herein in their entirety.

### STATEMENT REGARDING FEDERALLY SPONSORED RESEARCH OR DEVELOPMENT

This invention was made with Government support and the Government has certain rights in the invention.

### FIELD OF THE DISCLOSURE

The present invention relates in general to the application of sealant to fasteners, such as rivets and bolts, and more specifically to the application of sealant to fasteners for use in aerospace manufacture and repair.

### BACKGROUND

In many aerospace applications, particularly aircraft manufacture, fasteners are often used to connect one or more substrates together. Many fasteners, such as rivets, pins, threaded bolts, or other screw-type fasteners, pass through the substrates from an upper exposed surface (the top side) to the back-side of the substrates. Such fasteners can be secured on the backside by several methods including a shop head (buck tail), collar, nut, or nutplate.

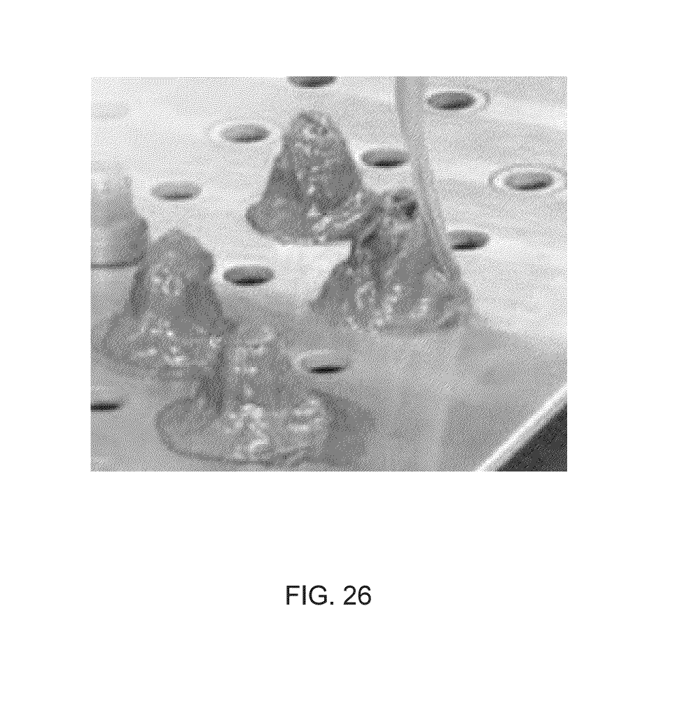

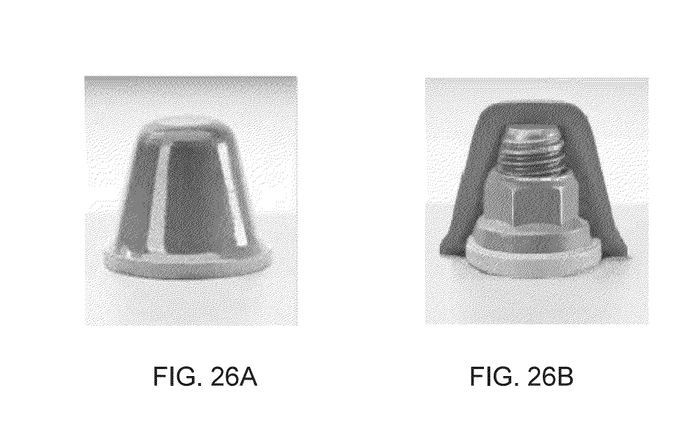

In many cases, sealant must be applied to the backside portion of the fastener, for example to prevent leakage or corrosion. Typically, sealant has been applied to directly exposed fasteners using a brush, spatula, or stick applicator. The results of such an application process are shown in FIG. 26. It is also known to pre-fill a sealant cap with a quantity of sealant and then place the filled sealant cap over the fastener. Such a process and the results are shown in FIGS. 27A to 27B. All of these known processes, however, suffer from various shortcomings.

What is needed therefore is an improved process for applying sealant to the backside of fasteners for use in aerospace manufacture and repair.

### SUMMARY OF THE INVENTION

An object of the invention, therefore, is to provide such an improved process for applying sealant to the backside of fasteners. Preferred embodiments of the present invention use a novel sealant cap as a mold for applying sealant. Embodiments of the present invention are especially suited for applying sealant to the backside of fasteners used in aircraft production. In preferred embodiments, the sealant caps allow the application of a metered amount of sealant only at the required/desired locations around an installed aircraft fastening element. Embodiments of the present invention thus prevent the over/under application of sealant and reduce the amount of time required to seal a fastener. Further, embodiments of the present invention help improve quality inspections by producing a consistent profile with smooth surfaces and well defined features making the identification of flaws much easier.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### DETAILED DESCRIPTION OF PREFERRED EMBODIMENTS

This disclosure, in general, relates to sealant caps used as molds for applying sealant over fasteners or fastener elements such as nutplates (collectively referred to herein as fasteners). Sealant caps according to embodiments of the invention can be filled with the desired amount of sealant for a particular fastener application and then placed over the fastener to mold the sealant in place until the sealant has cured. In particular embodiments, after curing is sufficiently complete, the sealant caps can then be removed from the fasteners leaving behind a metered amount of sealant only at the required/desired locations around an installed fastener.

Embodiments of the present invention are especially suited for applying sealant to the backside of fasteners used in aircraft production. Particularly for aerospace applications, it is desirable to apply a precisely metered amount of sealant because the application of too much sealant contributes to excess weight of an aircraft. Embodiments described herein allow a controlled amount of sealant to be added to the sealant cap rather than applying sealant directly to the fastener as in the prior art methods described above. The sealant cap is then used to control exactly where the sealant is applied and to mold the sealant in place. Embodiments of the present invention thus prevent the over/under application of sealant and reduce the amount of time required to seal a fastener. Removal of the sealant caps after the molding and curing processes are complete also reduces the weight of the finished aircraft. Further, embodiments of the present invention help improve quality inspections after fasteners are installed and sealed by producing a consistent profile with smooth surfaces and well-defined features that make the identification of flaws much easier.

Much of the description herein refers to sealant caps used to seal enclosed dome nutplates. However, embodiments of the present invention are equally suited for other simpler sealing applications where a high quality, repeatable, aesthetically pleasing seal is preferred or required. For example, the single-part sealant caps described below are especially suited for fasteners such as Eddie-bolts or other similar fasteners designed for blind applications where the anchor nuts are inaccessible.

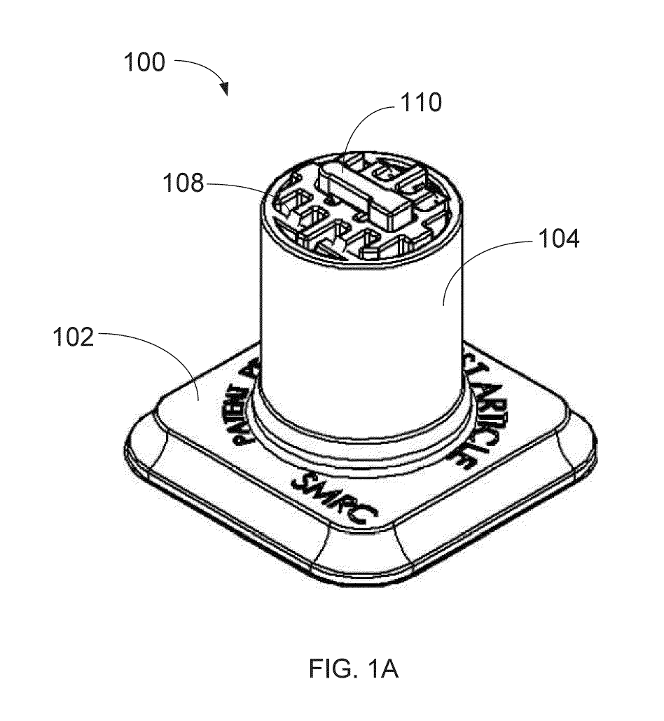

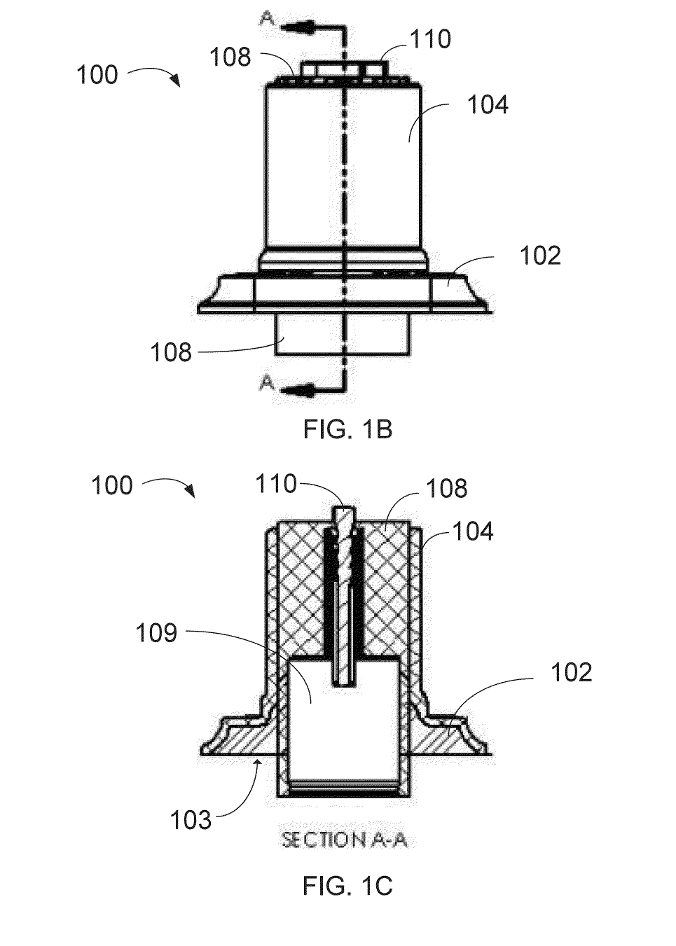

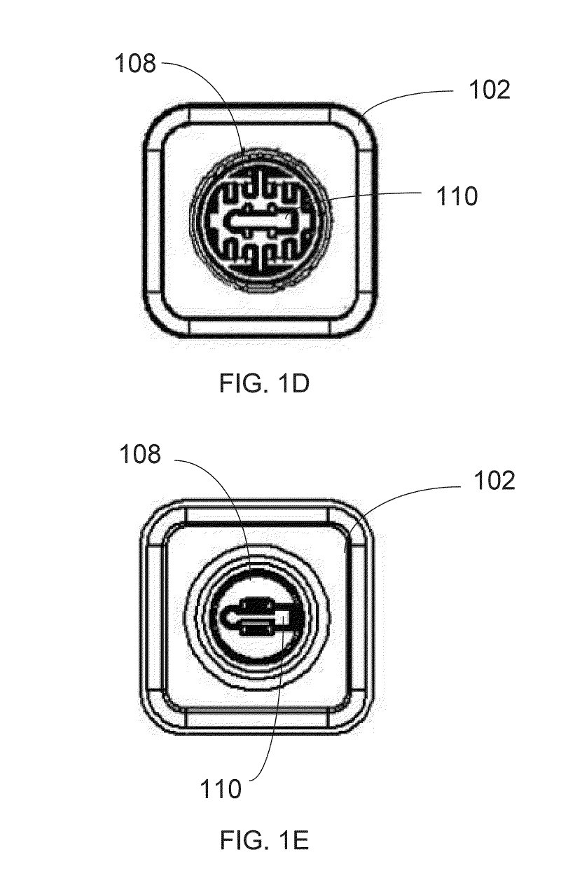

FIG. 1A illustrates a sealant cap 100 according to an embodiment of the present invention. FIG. 1B is a side view of sealant cap 100 of FIG. 1A. FIG. 1C is a cross-sectional view of sealant cap 100 taken along line A-A in FIG. 1B. FIG. 1D is a top-down view and FIG. 1E is a bottom-up view of sealant cap 100. As used herein, the terms top, upper, upward, and/or any similar terms, along with the terms bottom, lower, downward, and/or any similar terms will be used in accordance with the perspective shown in FIGS. 1A to 1C, regardless of the actual orientation of an installed fastener. In other words, the downward direction will be considered to be toward the substrate to with the fastener is attached, while the upward direction will be considered to be away from the substrate.

Sealant cap 100 is a multi-part sealant cap that includes mold base 102, plunger 108, and a stop tab or blade 110 that is used to adjust the sealant cap for fasteners components of different heights. Mold base 102 serves as the reservoir for the proper amount of uncured sealant for the particular fastener application, and has a central opening for receiving plunger 108. In the embodiment of FIG. 1A, the plunger is generally cylindrical, although other shapes could be used depending upon the fastener application, so the central opening is generally circular. In the embodiment of FIG. 1A, the outer edges of the mold base 102 are generally square, however other shapes can be used. Some types and arrangements of nutplates may require the shape of the base to be different, for example oval, round, or even having a different shape on either side of the fastener.

Central opening 120 is sized so plunger 108 can slide up or down relative to the mold base. In some embodiments, central opening can have grooves and/or ribs that match with corresponding ribs and/or grooves on the plunger to prevent the plunger from rotating relative to the mold base once it is installed. This helps ensure a tight enough fit that sealant is substantially prevented from escaping between the alignment cylinder and the mold base when the filled sealant cap is installed. In some embodiments, the exterior surface of the plunger can also have longitudinally arranged rows of teeth that mate with one or more interior edges or ratchets in the central opening. This generally holds the plunger in position with respect to the mold base, while still allowing the plunger to slide up or down upon the application of sufficient force. In particular embodiments, the arrangement of teeth and ratchets allows the plunger to be readily moved between an upper position and a lower position, but does not allow the plunger to be pulled up and out of the opening in the mold base, which helps ensure that the entire assembled sealant cap (plunger with stop blade and the mold base) will be completely removed once sealant curing is complete.

When installed into the mold base, plunger 108 is used to properly align the sealant cap with a fastener and to prevent sealant from being applied to portions of the fasteners. This serves to reduce material costs and reduce the overall weight of an aircraft. Plunger 108 has an upper portion that engages with the mold base and a lower portion that is generally cylindrical (to match the shape of the fastener portion or nutplate) with an internal cavity that will slide down over a portion of the fastener during installation. Stop blades 110 (as described below) can be used to prevent the plunger from sliding too far down the fastener. As shown in FIG. 4 (discussed below) in some embodiments, the bottom of the plunger will not slide down onto the faster further than the position shown by dashed line 122. This ensures that the sealant will completely cover the bottom shoulder of a typical nutplate fastener.

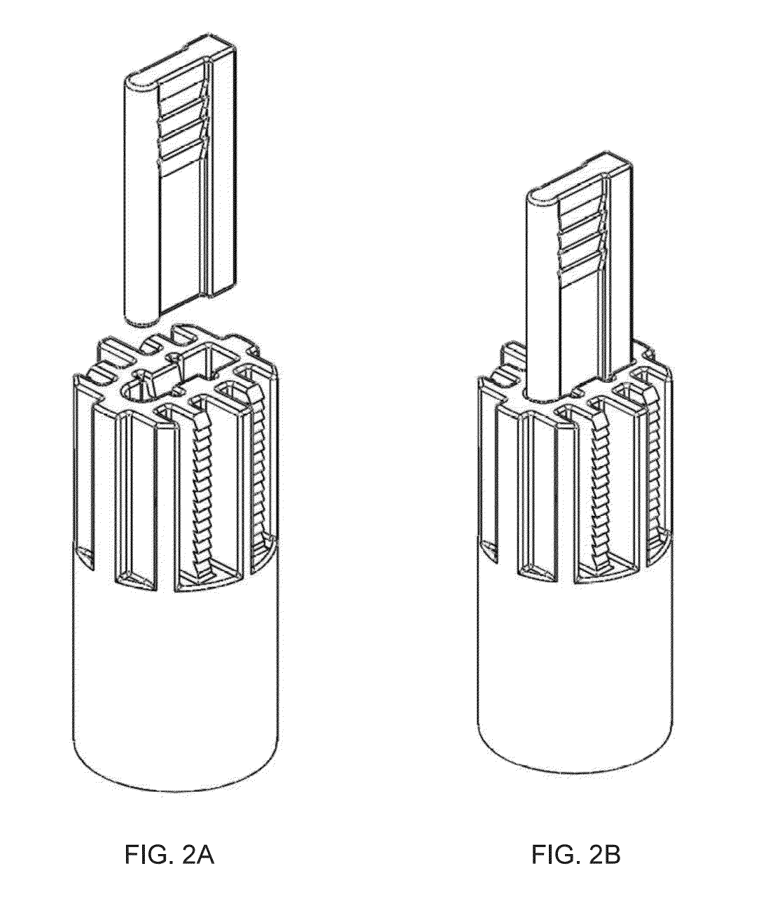

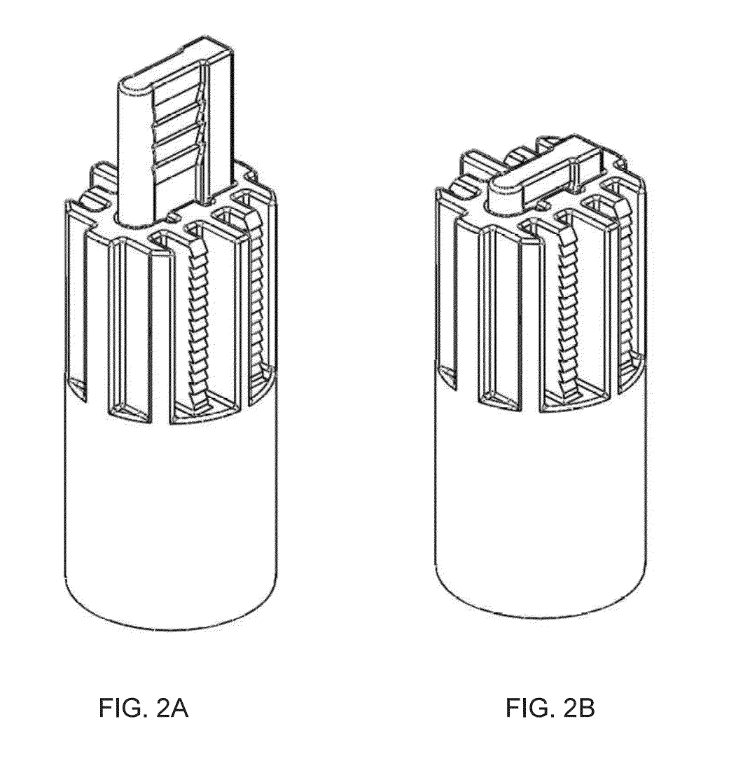

As shown in FIGS. 2A-2D, stop blade 110 can be inserted into a slot 224 in the top of plunger 108 and locked into a desired position. FIG. 2A is a schematic illustration of a stop blade being lowered to slot 224 for insertion. FIGS. 2B and 2C show stop blade 110 being inserted into plunger 108. And FIG. 2D shows stop blade 110 locked into position within the plunger as described in greater detail below. In some embodiments, once the stop blade is locked into position, the lower portion of stop blade 110 will make contact with the upper surface of the fastener as the open portion of the plunger slides onto the fastener during sealant cap installation. The shorter the height of the fastener, the deeper the stop blade will need to extend down into the internal cavity of the plunger so that the sealant cap will be installed correctly.

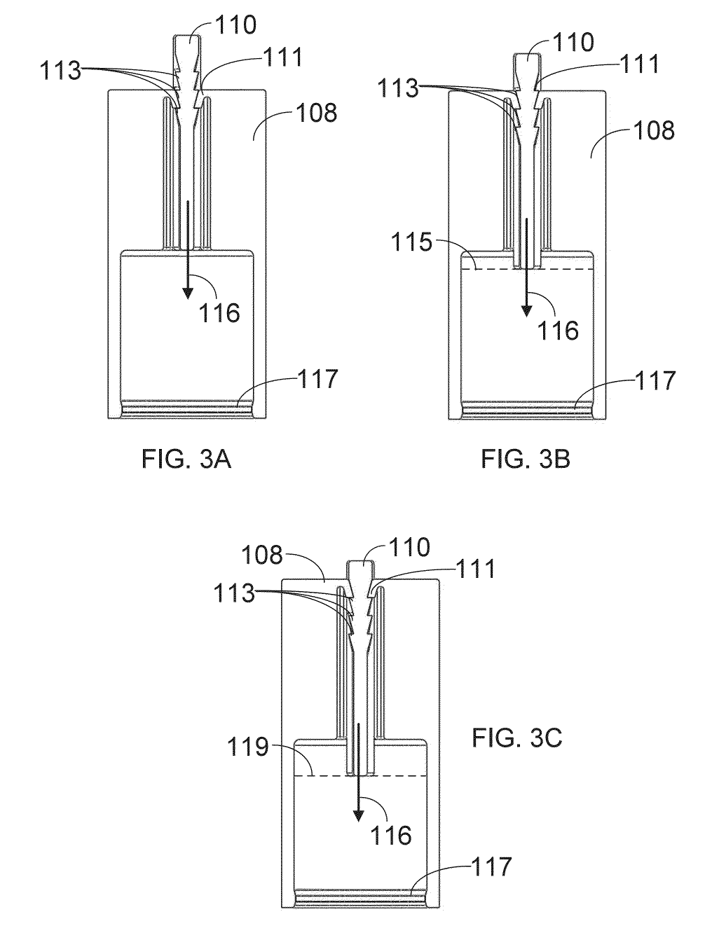

FIGS. 3A-3C show schematically a stop blade 110 locked into three different positions relative to the plunger 108. In FIG. 3A, stop blade 110 has been inserted into a slot extending through plunger 108 in the direction shown by arrow 116. In the illustrated embodiment, stop blade 110 has three different positions defined by the positions of teeth 113. As the stop blade is pressed down through the slot in plunger 108, the lower row of teeth 113 will slide past flexing interior catches 111 in the plunger slot and snap into place at a first position. As shown, stop blade 110 has three different positions defined by the positions of teeth 113, although different numbers of teeth and different length stop blades could also be used. In FIG. 3A, stop blade 108 has been snapped into a first position, where the lower portion of the stop blade does not extent into the internal cavity 118 of plunger 108. Thus, the plunger of FIG. 3A could slide down over a fastener until the upper surface of the fastener made contact with the upper limit of internal cavity 118.

In FIG. 3B, stop blade 110 has been moved in the direction shown by arrow 116, until it has snapped into a second position where the middle row of teeth 113 are engaged by flexing interior catches 111. In this position, the lower surface of the stop blade extends into the plunger internal cavity 118. Thus the plunger of FIG. 3B could slide down over a fastener until the upper surface of the fastener made contact with the snap blade. In that case, the upper surface of the fastener would be at the position shown by dashed line 115.

In FIG. 3C, stop blade 110 has been moved further in the direction shown by arrow 116, until it has snapped into a third position where the upper row of teeth 113 are engaged by flexing interior catches 111. In this position, the lower surface of the stop blade extends even further into the plunger internal cavity 118. Thus the plunger of FIG. 3B could slide down over a fastener until the upper surface of the fastener made contact with the snap blade at the position shown by dashed line 119. In the illustrated embodiment, if snap blade 110 were moved further in the direction shown by arrow 116, it would snap past the interior catches and could slide completely into the interior cavity 118 for removal and possible re-installation.

In particular embodiments, the different lock positions for a stop blade will each correspond to a proper plunger placement for a different standard fastener height. For example, with respect to nutplate fasteners, for a given diameter of nutplate, a series of different fastener heights are typically used with each varying from the previous nutplate in the series by 1/16 inches. By setting the distance between the stop blade teeth so that each step reduces fastener height by 1/16 inches, each step will correspond to proper installation of a typical fastener. As will be appreciated by persons of skill in the art, sealant caps according to embodiments described herein could be produced in any desired diameter, shape, or height to match virtually any desired fastener size.

In some embodiments, the interior diameter of internal cavity 118 will be just slightly larger than the fastener on which the sealant cap is being installed. Integral o-rings 117 (or a similar narrowing structure) at the base of interior cavity 118 can have a narrower diameter that is roughly equal to (or even slightly smaller than) the exterior diameter of the fastener. Because plunger 108 can be made from am at least slightly elastic plastic or polymer (as described below) the flexibility of the plunger can be used to insure a snug fit around the base of the plunger. This not only holds the sealant cap in position, but also helps insure than no sealant can squeeze up into the plunger cavity upon installation.

FIG. 4 is a schematic illustration of a plunger with an inserted stop blade ready to be inserted into mold base 102. In the embodiment of FIG. 4, as discussed above, an arrangement of longitudinal rows of teeth on the exterior of the plunger which engage with one or more lips or ratchets on the mold body 102, such as ratchets 225 within central opening 120, requires the plunger to be inserted from the bottom of mold base 102 in the direction shown by arrow 426.

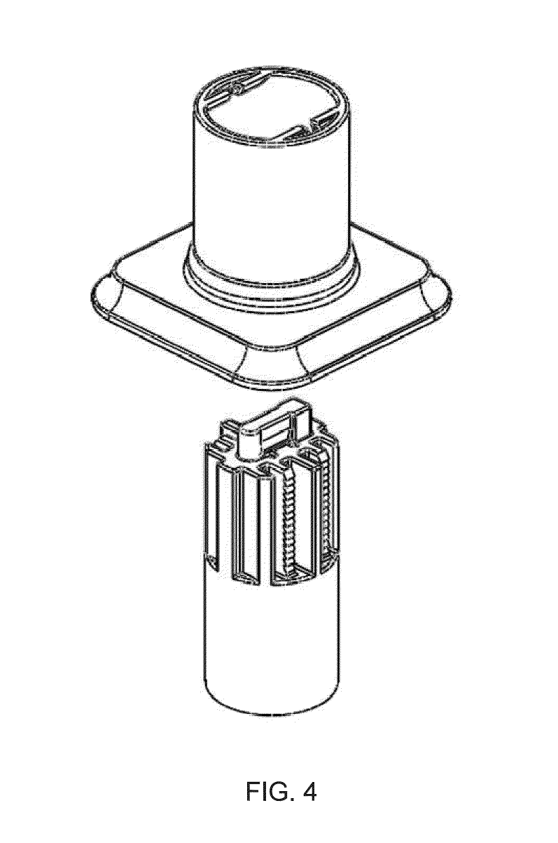

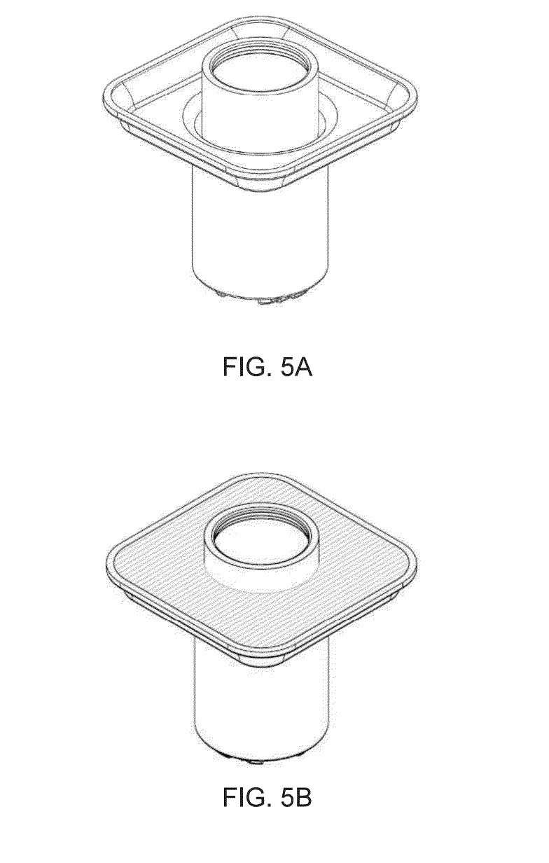

In particular embodiments, once a sealant cap such as the embodiment shown in FIG. 1A has been assembled, a metered amount of uncured (or at least partially uncured) sealant can be added to the sealant cap rather than applying sealant directly to the fastener. In order to add sealant, the sealant cap is placed in an inverted position as shown in FIG. 5A with the underside of mold base 102 facing upward. In this position, the underside of mold base 102 forms a bowl-like structure having an interior space 103. The underside of mold 102 is filled with an appropriate amount of an uncured sealant as shown in FIG. 5B. To prevent sealant from entering the interior cavity of plunger 108, the plunger can be positioned within the central opening of mold base 102 so that the bottom of plunger 108 will extend beyond the lower edges of the mold base.

“Sealant” as used herein refers to material that can be applied to a seam, gap, or interface between two materials to form a barrier through the physical properties of the sealant itself and by adhesion to one or more substrate materials against penetration by moisture, air flow, and/or other liquids and/or gases. Sealant formulations suitable for practicing some embodiments of the invention will be flowable when in an uncured or partially uncured condition, but which become at least largely solid (non-flowable) as the sealant cures. Embodiments of the invention are not limited to any particular type of sealant or method of curing. In some embodiments, a suitable sealant will be one that is approved for use with aerospace fasteners.

In some embodiments, a suitable sealant will be flowable when uncured or partially uncured, and will also have a high enough viscosity to maintain position and shape when deposited into the mold base reservoir and then inverted during application. Examples of sealants suitable for use with embodiments of the present invention would be sealants that comply with U.S. military specification AMS 3277, such as PR-2001 Fuel Tank Sealant available commercially from PRC-DeSoto, and sealants that comply with U.S. military specification AMS 3281, such as PR 1776 also available from PRC-DeSoto, or AC380 available from 3M.

Filling the mold base reservoir should be done so as to avoid introducing air bubbles in the sealant. In some embodiments, both the positioning/inversion of the sealant cap and the addition of the uncured sealant to the mold base can be performed in an automated fashion using, for example a robotic positioning system and a computer-controlled sealant dispenser that dispenses the uncured sealant through a nozzle or tip. In other embodiments, positioning of the sealant cap and/or application of the sealant can be performed by hand.

Curing times for suitable sealants can vary widely, from minutes to hours after curing is initiated. In some embodiments, the mold can be prefilled with sealant automatically, and subsequently cooled to a temperature at which the sealant cure rate is halted or drastically slowed. This process can be done off-site, allowing the prefilled molds to be delivered ready to thaw and install. The use of pre-mixed frozen sealant is well known in the prior art.

In some embodiments, the sealant can be added until the mold base is completely filled. In automated processes, the amount of sealant to be added to the mold base can be precisely metered using known methods.

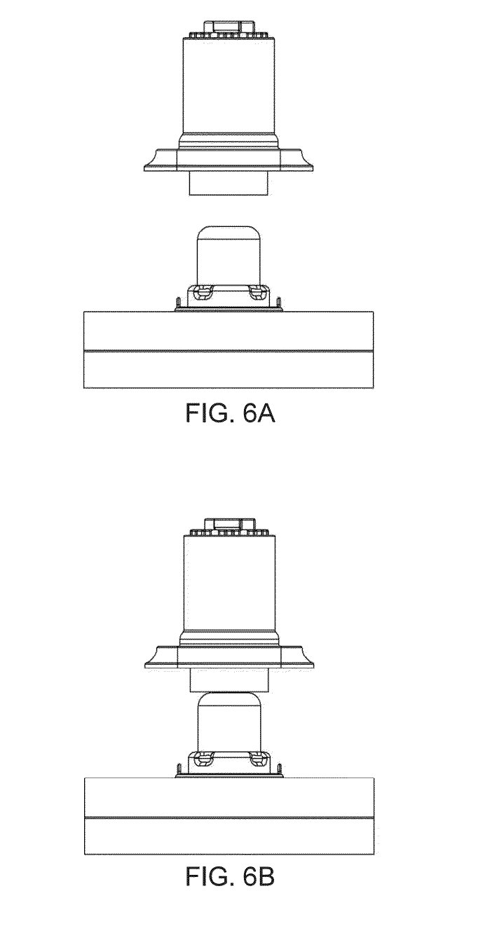

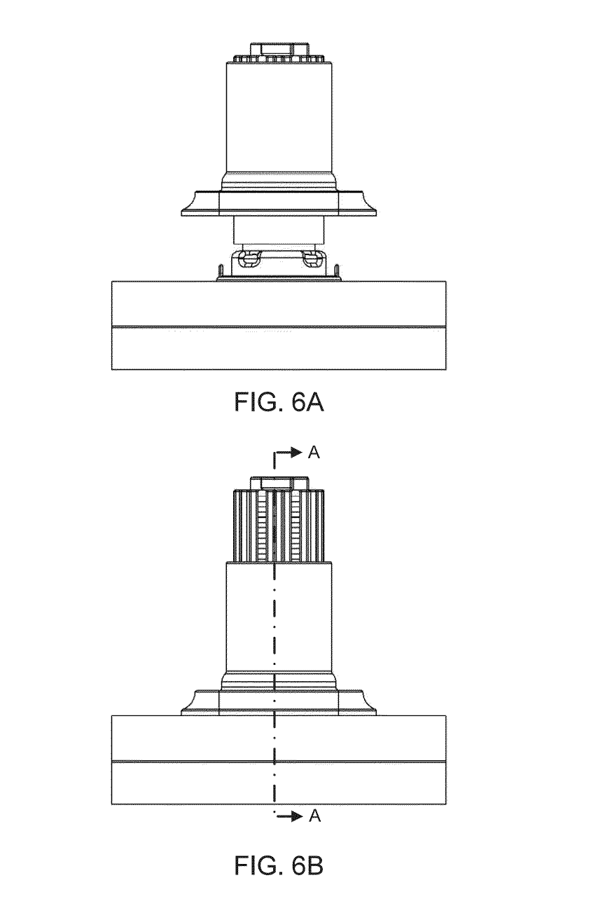

Once filled, the sealant cap 100 can re-oriented top side up and installed onto a fastener as shown in FIGS. 6A-6D, being careful to maintain rotational alignment with the fastener element if applicable. The lower, open end of plunger 108 is placed over the fastener to be sealed in order to properly align the filled sealant cap. Plunger 108 is pushed down over the fastener until the lower portion of the stop blade (or in some embodiments the top of the plunger cavity) makes contact with the top of the nutplate. The filled mold base then slides down the plunger until the mold base makes contact with the substrate as shown in FIG. 6D. Preferably, the amount of sealant added to mold 102 is sufficient to cause a small amount of sealant to be extruded abound the entire outer edge of base when the sealant cap is pushed down into position. This provides a visual indication that the sealant has been applied completely around the fastener.

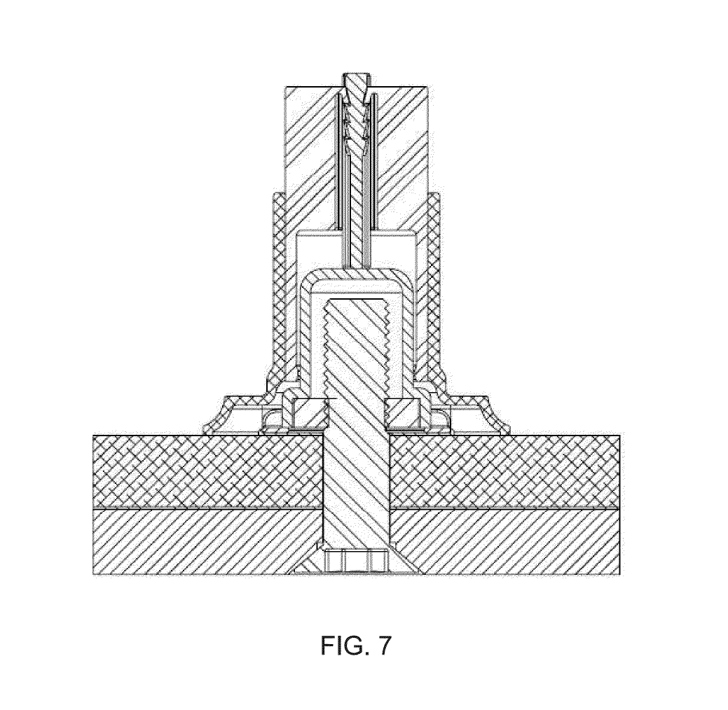

FIG. 7 is a cross-sectional view taken along line A-A in FIG. 6D of a sealant cap in place over the backside of a fastener according to an embodiment of the present invention. As shown in FIG. 7, plunger 108 is in position over nut element 706, and the base of mold 102 is in contact with substrate 740. The area 741 underneath mold base 702 and above the substrate 740 will be filled with sealant, with sealant being in direct contact with the base of the fastener 712 (or any covering such as a nut plate). However, the upper portion of the fastener (such as the nutplate dome 742) will not be covered by or in contact with the sealant. Any sealant on this upper surface or portion of the fastener would be unnecessary and would thus result only in excess weight and added material expense.

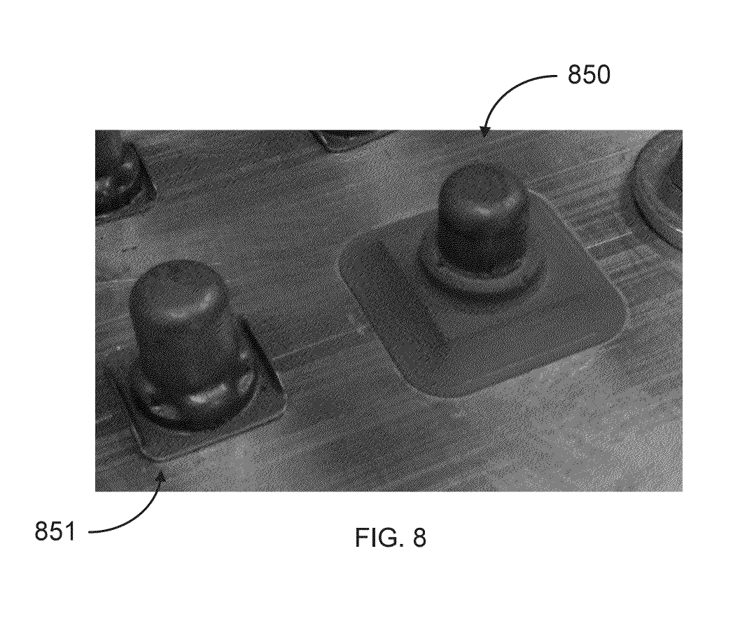

Once the sealant has sufficiently cured, the entire sealant cap, including plunger 108, stop blade 110, and mold base 102 can be removed, leaving behind a sealed fastener. FIG. 8 shows a sealed nutplate dome on the backside of a fastener alongside an unsealed nutplate dome on the backside of a different fastener.

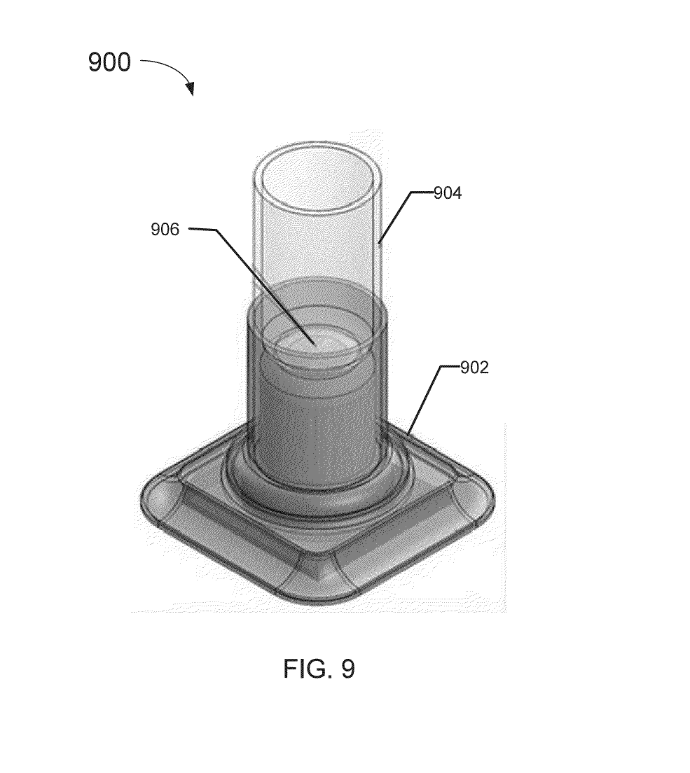

FIG. 9 shows a sealant cap 900 according to another embodiment of the present invention. Sealant cap 900 is preferably a two-part sealant cap that includes mold 902 and a separate alignment cylinder 904. Mold 902 serves as the reservoir for the proper amount of uncured sealant for the particular fastener application, while alignment cylinder 904 is used to both properly align the mold with the fastener 906 and to prevent sealant from being applied to unnecessary portions of the fastener to be sealed.

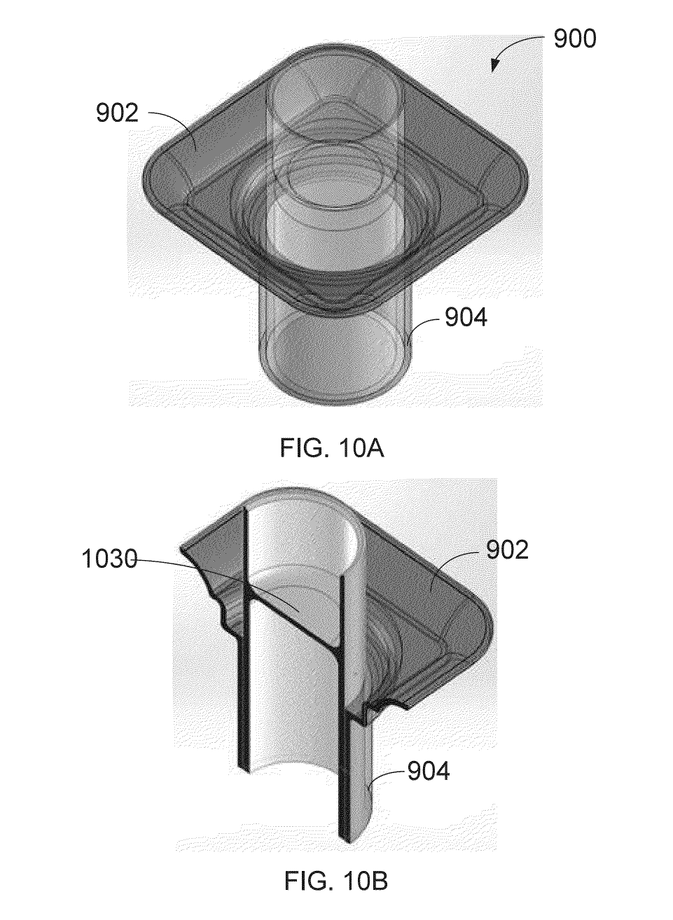

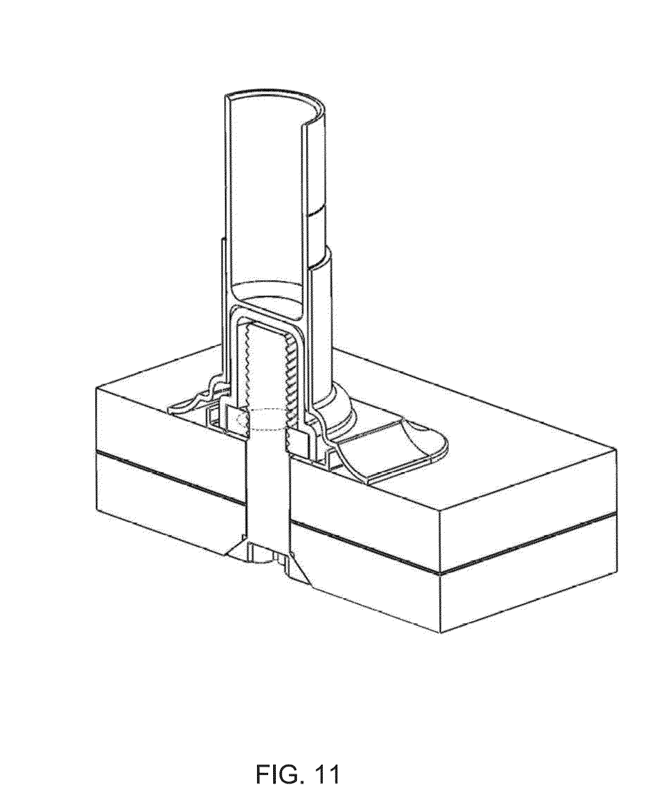

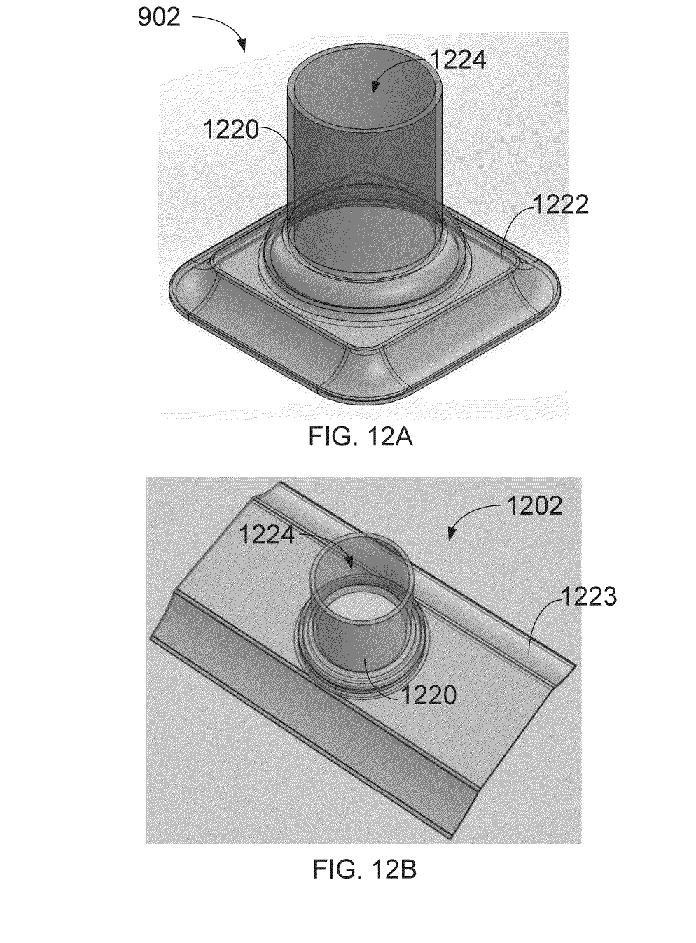

FIG. 10A shows a bottom view of sealant cap 900, while FIG. 10B shows a longitudinal cross-section of sealant cap 900, including mold 902 and alignment cylinder 904. FIG. 11 shows a cross-sectional view of sealant cap in place over the backside of a fastener 1106 according to a preferred embodiment of the present invention. As shown in FIG. 6A, the underside of mold 902 (facing upward in the inverted view of FIG. 6A) forms a bowl-like structure that serves as a reservoir of uncured sealant. Mold 902 preferably has a cylindrical neck 820 and a base 822, which serves to form the reservoir and define the outer shape and edges of the applied sealant. The outer edges of the base 1222 are generally square, however other shapes can be used. For example, in FIG. 12B, which shows another embodiment of a sealant cap mold 1202, the base 1223 is rectangular in shape with a lateral length that is greater than the width of the base 1223. Other types of nutplates will require the shape of the base to be different, for example oval, round, or even having a different shape on either side of the fastener.

Cylindrical neck 1220 preferably has a central opening 1224 through which the alignment cylinder 904 is inserted. Central opening 1224 is sized so the alignment cylinder can slide up and down relative to the mold base, but with a tight enough fit that sealant is substantially prevented from escaping between the alignment cylinder and the mold base when the filled sealant cap is installed (as described below).

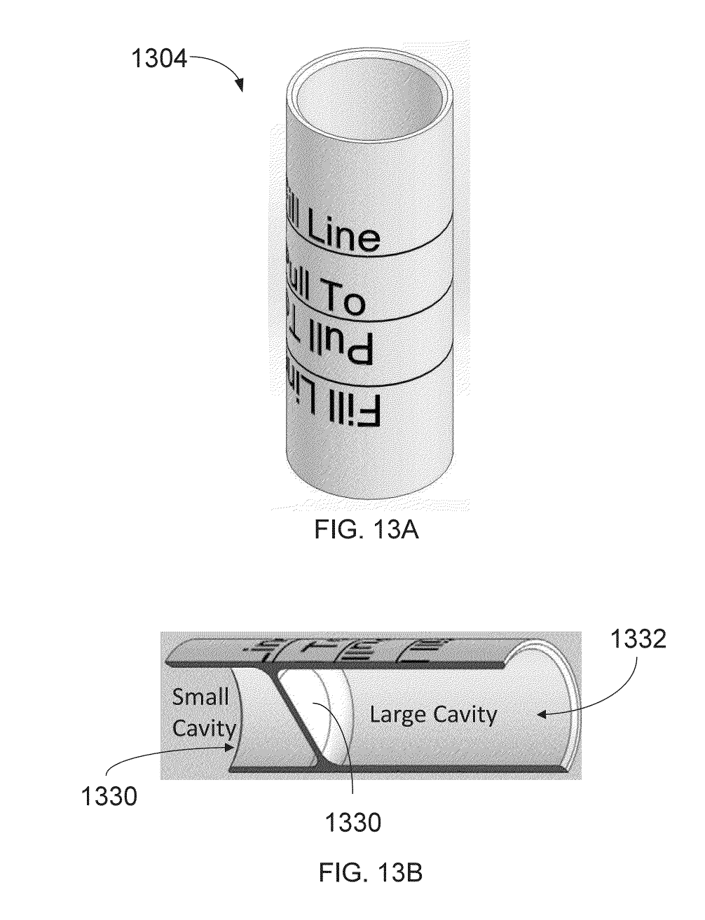

FIG. 13A shows a separate sealant cap alignment cylinder 1304 according the embodiment of FIG. 5. FIG. 13B is a cross-sectional view of the sealant cap alignment cylinder of FIG. 13A. Alignment cylinder 1304 can have a central divider 1330, which separates the interior of the cylinder into two different sized cavities—a smaller cavity 1331 and a larger cavity 1332. As discussed below, this allows the alignment cylinder to be used with different sized fasteners. The divider automatically positions the alignment cylinder in the vertical direction for the most common nutplate height (in the smaller cavity). The other end (having the larger cavity) can accommodate other nutplate heights by utilizing “pull to” lines.

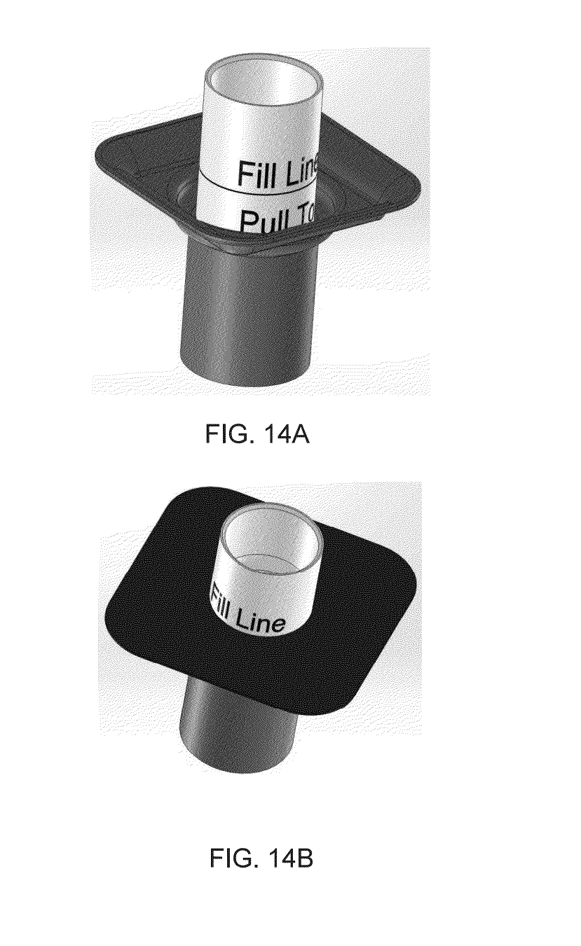

In the operation of two-part sealant cap 1300 according to an embodiment of the invention, a fastener element such as a nutplate 1306 is first cleaned and prepared, as is known in the prior art. Alignment cylinder 1304 preferably positioned inside the central opening of mold 1302 so that the top of alignment cylinder 1304 is flush with the top cylindrical neck. This results in the bottom of alignment cylinder 1304 extending well beyond the mold base. FIG. 14A shows a sealant cap according to a preferred embodiment of the present invention with the sealant cap alignment cylinder in place. Sealant cap 1300 is then placed in an inverted position as shown in FIG. 14A. The underside of mold 1302 is filled with an appropriate amount of an uncured sealant as shown in FIG. 14B, which shows the sealant cap of FIG. 14A with sealant added to the sealant cap up to the fill line on the alignment cylinder.

In some embodiments, the sealant can be added until the mold base is completely filled. In particular embodiments, the alignment cylinder (which is positioned in the center of the mold base) can have one or more fill lines formed on the surface of the cylinder indicating the appropriate sealant level (as shown in FIGS. 14A and 14B). In automated processes, the amount of sealant to be added to the mold base can be precisely metered using known methods.

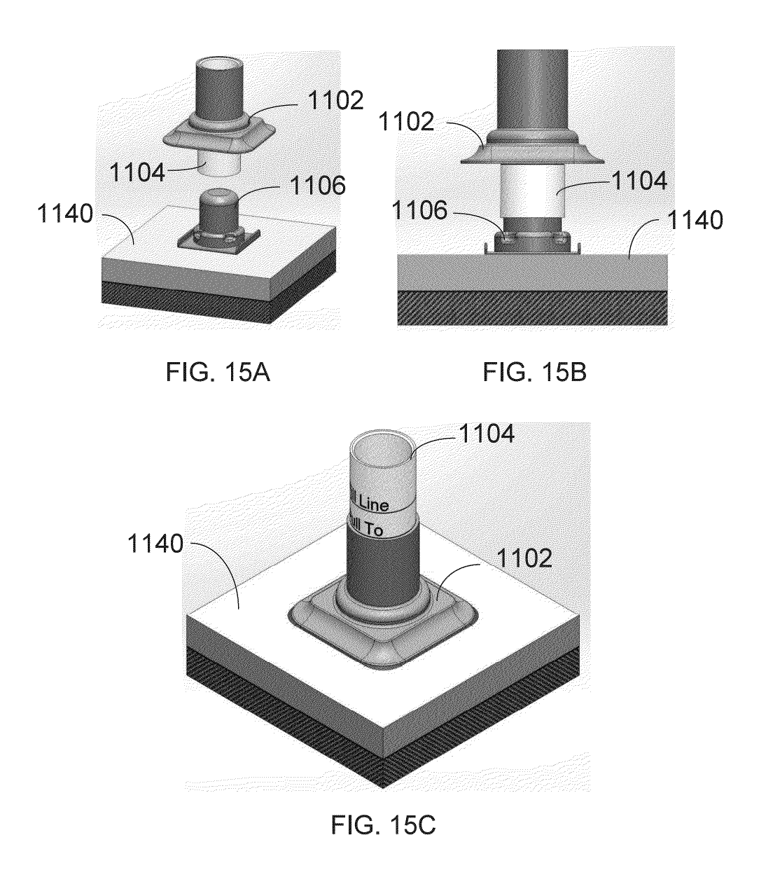

Filled sealant cap 1100 can then be re-oriented top side up and placed over a fastener element 1106 as shown in FIG. 15A, being careful to maintain rotational alignment with the fastener element if applicable. Alignment cylinder 1104 is placed over the fastener to be sealed in order to properly align the filled sealant cap. Alignment cylinder 1104 is pushed down over the fastener until the cylinder divider of the alignment cylinder makes contact with the top of the nutplate, as shown in FIG. 15B. The filled mold base then slides down the alignment cylinder until the mold base makes contact with the substrate 1140 as shown in FIG. 15C. Preferably, the amount of sealant added to mold 1102 is sufficient to cause a small amount of sealant to be extruded abound the entire outer edge of base when the sealant cap is pushed down into position. This provides a visual indication that the sealant has been applied completely around the fastener.

FIG. 11 is a cross-sectional view of sealant cap in place over the backside of a fastener according to a preferred embodiment of the present invention. As shown in FIG. 11, alignment cylinder 904 is in position over nut element 1106, and the base of mold 902 is in contact with substrate 1140. The area underneath mold base and the substrate will be filled with sealant, with sealant being in direct contact with the base of the fastener (or any covering such as a nut plate). However, the upper portion of the fastener (such as the nutplate dome in FIG. 3) will not be covered by or in contact with the sealant. Any sealant on this upper surface or portion of the fastener would be unnecessary and would thus result only in excess weight and added material expense. Once the sealant has cured, sealant mold 902, and alignment cylinder can be removed, leaving behind a sealed fastener.

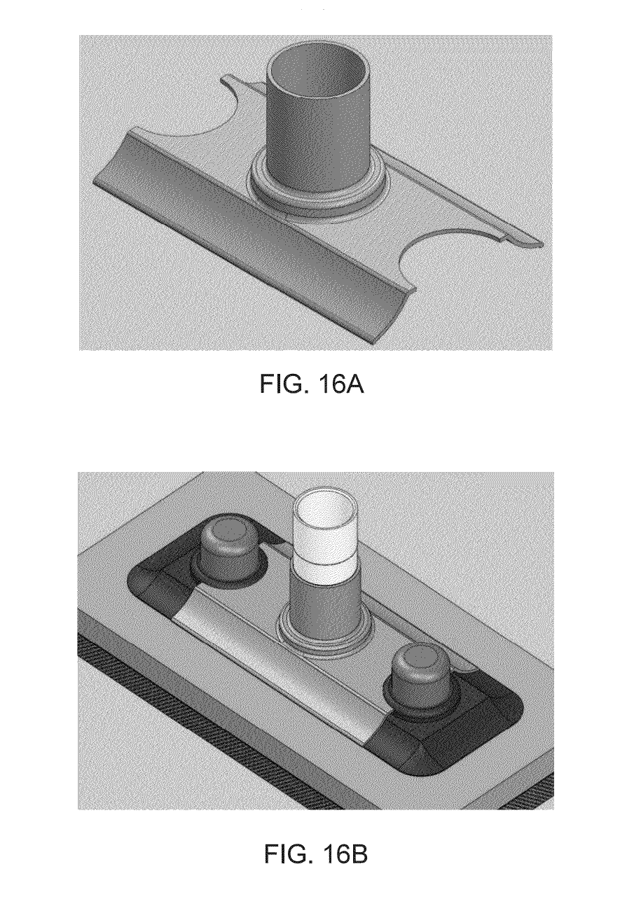

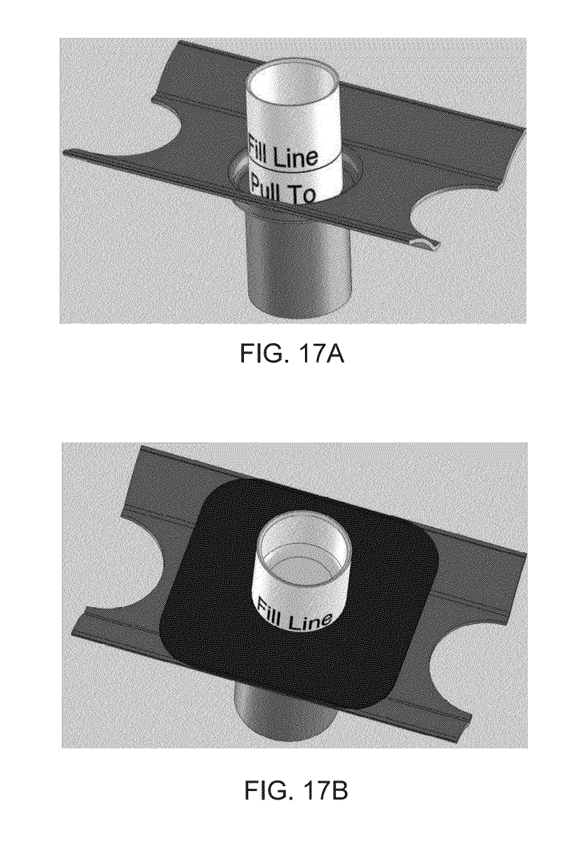

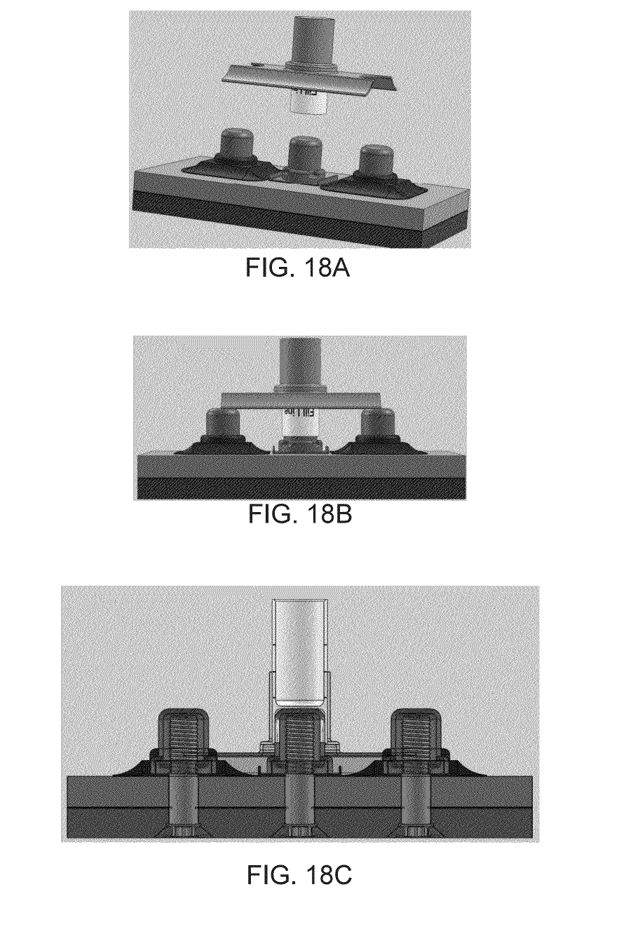

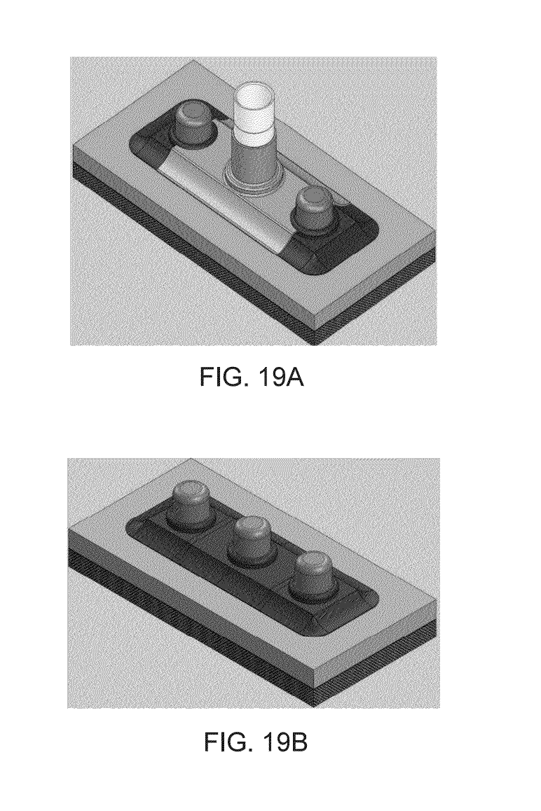

FIG. 16A to FIG. 19B illustrate the steps described above in an embodiment of the present invention that can be used when the fasteners are located too close together for the sealant caps as described above. As shown in these figures, in some embodiments, the mold base can be notched to fit around fasteners (whether unsealed or previously sealed) that are located very close to the fastener being sealed. FIG. 16A shows a sealant cap 1300 in which the mold base has been trimmed to allow sealant to be applied to fasteners located very close together. FIG. 16B shows sealant cap 1300 in place over the backside of a fastener. FIG. 17A shows sealant cap 1300 with the a sealant cap alignment cylinder in place for filling the sealant cap with sealant, while FIG. 17B shows sealant cap 1300 with sealant added to the sealant cap up to the fill line on the alignment cylinder. FIGS. 18A-18C illustrate the steps in placing sealant cap 1300 filled with sealant over the nutplate dome on the backside of a fastener. FIG. 19A shows sealant cap 1300 in place over the backside of a fastener according to a preferred embodiment of the present invention. FIG. 19B shows a sealed nutplate dome on the backside of a fastener after sealant cap 900 has been removed after the sealant has cured.

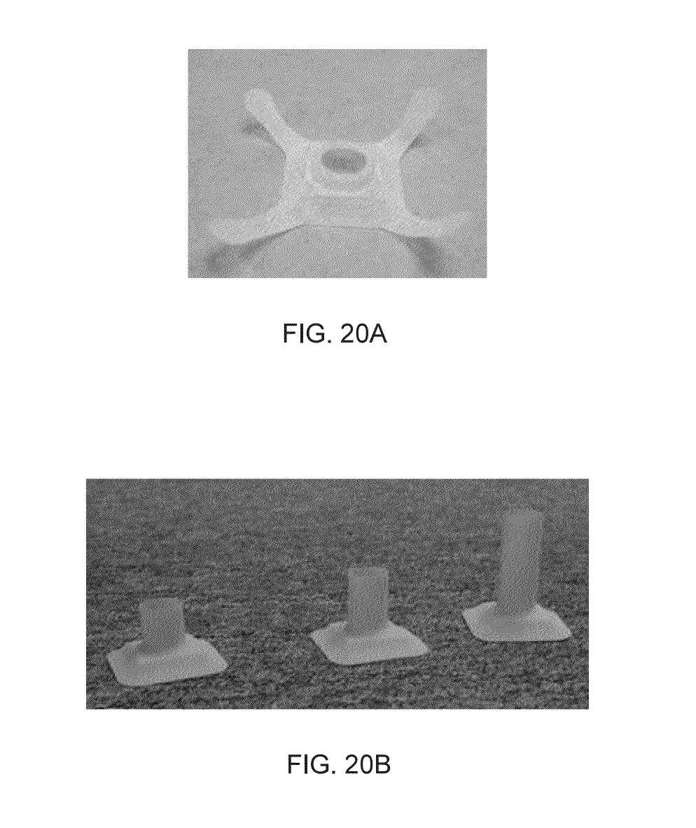

FIG. 20A shows a sealant cap base according to another embodiment of the present invention with “wings” extending from the four corners of the rectangular mold base to make the sealant cap easier to remove after the sealant is cured.

FIG. 20B shows sealant cap bases with cylindrical necks of varying sizes/lengths to accommodate different size fasteners.

In some embodiments, the mold portion of the sealant cap will be formed from a transparent or translucent material that will allow bubble or voids in the sealant to be observed from the outside when the filled sealant is in position over a fastener. In some embodiments, a portion of the sealant cap, such as the molds shown in FIG. 18 can be made in different colors corresponding to different size fasteners. The colors can be very bright or even fluorescent to help insure that none of the sealant caps will be left in place accidentally after the sealant has cured.

In some embodiments of the present invention, a one-piece sealant cap (without an alignment cylinder) can be used. Such a sealant cap will typically be less expensive, but will result in a layer of sealant over the entire fastener. Such a one-piece sealant cap is shown in FIGS. 20A and 20B.

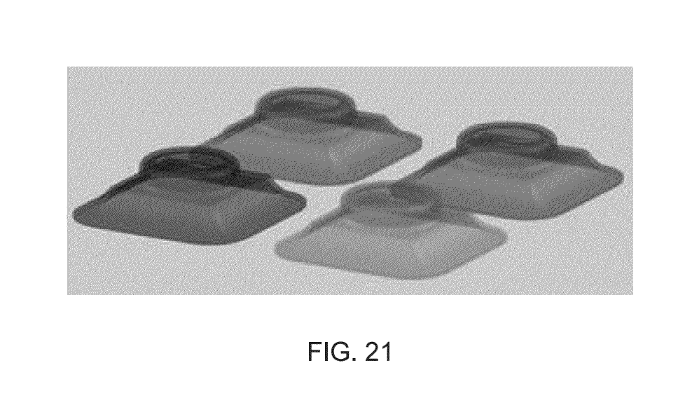

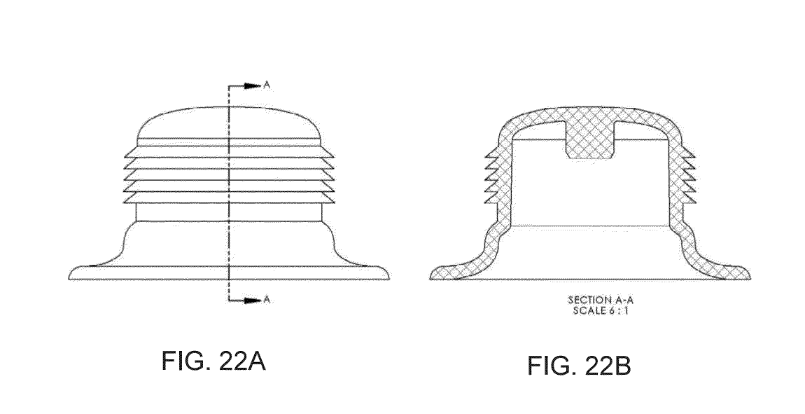

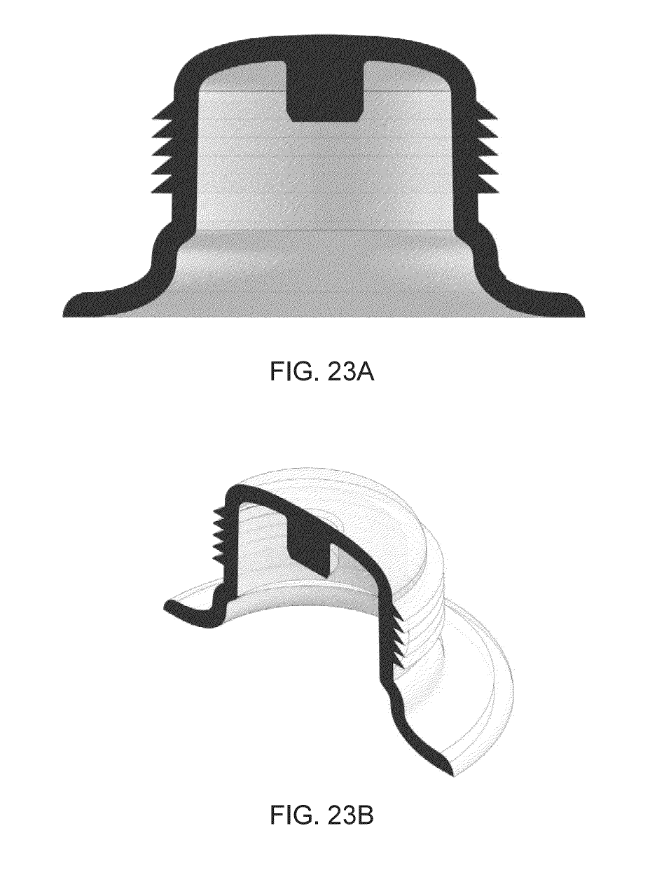

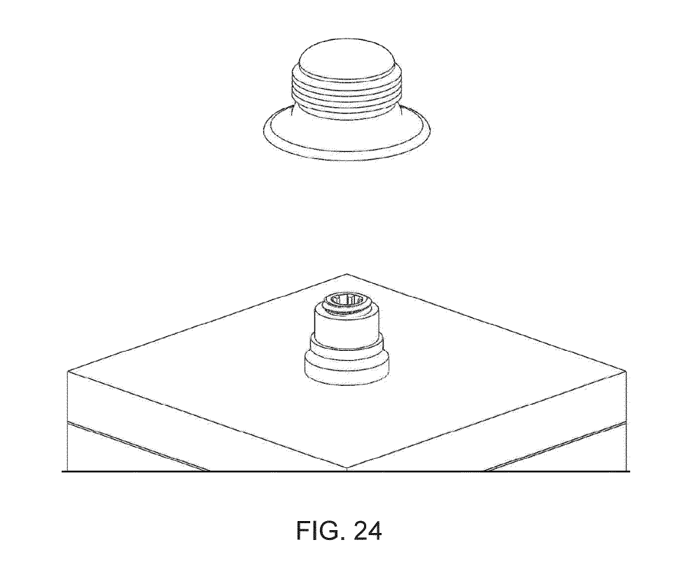

Another embodiment of a one-piece sealant cap is shown in FIGS. 22A 22B. The sealant cap in FIGS. 22A-B features an alignment stub 2201 in the center of the underside of the cap 2202. This stub will match up with the center slot or hole in numerous known specialty aerospace fasteners such as Eddie-Bolts. External ridges 2203 make it easier to grip the cap 2200 to remove it after the sealant has dried. FIGS. 23A-B show another embodiment of one-piece sealant cap. FIG. 24 shows a cap 2200 oriented over a fastener. To install the cap, the entire one-piece cap is filled with sealant, placed over the fastener, and aligned to the fastener using the alignment stub.

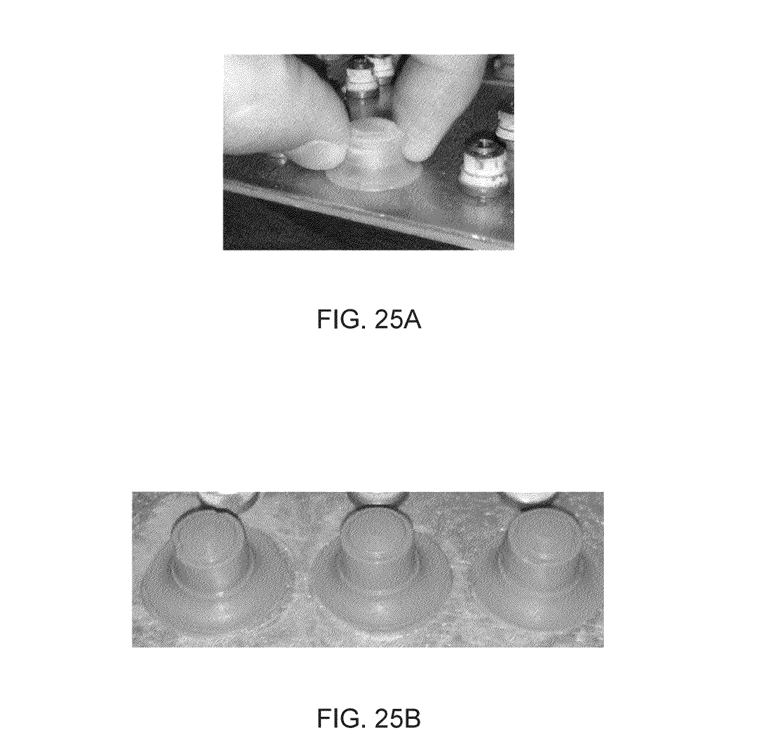

Once the sealant has cured, the one-piece sealant cap can be removed from the fastener, as shown in FIG. 25A. FIG. 25B shows a row of fasteners to which sealant has been applied using a one-piece sealant cap. In some embodiments, sealant on unnecessary areas of the fastener can be wiped off or otherwise removed, either before or even after the sealant has cured.

The invention described herein has broad applicability and can provide many benefits as described and shown in the examples above. The embodiments will vary greatly depending upon the specific application, and not every embodiment will provide all of the benefits and meet all of the objectives that are achievable by the invention. Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention. After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present). Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Although the present invention and its advantages have been described in detail, it should be understood that various changes, substitutions and alterations can be made to the embodiments described herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A sealant cap for applying a sealant to the portion of a fastener comprising: a sealant cap with a reservoir for holding a quantity of sealant; an alignment means for aligning the cap over the fastener; a sealant at least partially filling the reservoir.

2. A sealant cap assembly for applying a sealant to the portion of a fastener extending above a substrate through which the fastener is attached, the sealant cap assembly comprising:
a molding base having an internal cavity for holding a quantity of sealant, the molding base being generally cup-shaped and having a lower edge defining the mouth of the internal cavity and configured to contact the substrate when the filled molding base is placed in position over a fastener, and a central opening through the molding base opposite the lower edge; and
a plunger sized to fit though the central opening so that it extends into the inner cavity and having an internal cavity sized to slide over an upper portion of a fastener when the filled sealant cap assembly is in position so that the upper portion is shielded from sealant in the internal cavity; and
an adjustable tab that can be used to adjust the height of the fastener portion that will fit into the internal cavity in order to adjust the sealant cap assembly to fit different sizes of fasteners.

3. A sealant cap assembly for applying a sealant to the portion of a fastener extending above a substrate through which the fastener is attached, the sealant cap assembly comprising:
a molding base having an internal cavity for holding a quantity of sealant, the molding base being generally cup-shaped and having a lower edge defining the mouth of the internal cavity and configured to contact the substrate when the filled molding base is placed in position over a fastener, and a central opening through the molding base opposite the lower edge; and
an alignment cylinder sized to fit though the central opening so that it extends into the inner cavity and sized to slide over an upper portion of a fastener when the filled sealant cap assembly is in position so that the upper portion is shielded from sealant in the internal cavity.

4. A method of applying sealant to a fastener extending through a substrate using a sealant cap according to claim 1, the method comprising:
placing the alignment cylinder in position through the central opening in the molding base so that the lower portion of the alignment cylinder extends into the inner cavity and past the lower edge of the molding base;
adding a quantity of uncured sealant to the inner cavity, the quantity being sufficient to substantially fill the inner cavity to the level of the lower edge;
placing the filled sealant cap assembly in position over a fastener so that the lower opening in the alignment cylinder is directly over the fastener;
lowering the sealant cap so that the upper portion of the fastener slides into the alignment cylinder;
continuing to lower the sealant cap until the lower edge of the molding base is in contact with the substrate surface;
confirming that a small amount of uncured sealant extrudes around the entire lower edge of the sealant cap to provide a visual indication that the sealant has been applied completely around the fastener;
allowing the sealant to cure; and
removing the sealant cap assembly from the sealed fastener.
